(19) United States
(12) Patent Application Publication
(10) Pub. No.: US 2019/0216020 A1
(43) Pub. Date: Jul. 18, 2019

(54) CROP SENSOR

(71) Applicant: Hewlett-Packard Development Company, L.P., Spring, TX (US)

(72) Inventor: Steven J. Simske, Fort Collins, CO (US)

(73) Assignee: Hewlett-Packard Development Company, L.P., Spring, TX (US)

(21) Appl. No.: 16/330,245

(22) PCT Filed: Oct. 3, 2016
(86) PCT No.: PCT/US2016/055202

§ 371 Date: Mar. 4, 2019

(51) Int. Cl. A01G 7/04; A01G 7/06

(52) U.S. Cl. CPC A01G 7/04; B33Y 80/00; A01G 7/06

(57) ABSTRACT

A crop sensor includes: a housing sized and shaped to correspond to a foodstuff of a crop; a sensor to sense a physiochemical parameter relative to growth of the crop; and an energy-harvesting unit to generate electrical energy for the sensor from movement of the housing.

### BACKGROUND

Modern technology has made and is making significant changes in the ancient field of agriculture. For example, satellite imagery may be used to track weather and temperature patterns that have significant impact on crop quality and quantity. Sophisticated models using archived and current environmental data may drive decisions and timing for planting, fertilizing and harvesting agricultural crops. More data on environmental conditions allows farmers to optimize efforts to increase crop quality and quantity.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 is an illustration of an example crop sensor consistent with the disclosed implementations.

FIG. 1A is an illustration of another example crop sensor consistent with the disclosed implementations.

FIG. 2 is an illustration of another example crop sensor consistent with the disclosed implementations.

FIG. 2A is an illustration of another example crop sensor specifically for training an energy-harvesting unit consistent with the disclosed implementations.

FIG. 2B is an illustration of another example crop sensor consistent with the disclosed implementations.

FIG. 3 is a flowchart of an example method of forming a crop sensor consistent with the disclosed implementations.

FIG. 4 is a flowchart of another example method of forming a crop sensor consistent with the disclosed implementations.

FIG. 5 is a flowchart of an example method of operating a crop sensor consistent with the disclosed implementations.

FIG. 6 is a flowchart of another example method of operating a crop sensor consistent with the disclosed implementations.

Throughout the drawings, identical reference numbers designate similar, but not necessarily identical, elements.

### DETAILED DESCRIPTION

As noted above, more data on environmental conditions allows farmers to optimize efforts to increase crop quality and quantity. Accordingly, the present specification describes a crop sensor that can be deployed throughout the lifecycle of a crop. For example, the described crop sensor could potentially be planted with a crop, remain in place during crop growth and be harvested with the crop. This sensor can provide ongoing and specific monitoring of any number of agricultural or physicochemical parameters to inform a decision about crop planting, management and harvesting.

In one example, the present specification describes a crop sensor that includes: a housing sized and shaped to correspond to a foodstuff of a crop; a sensor to sense a physiochemical parameter relative to growth of the crop; and an energy-harvesting unit to generate electrical energy for the sensor from movement of the housing.

In another example, the present specification describes an example crop sensor that includes: a housing sized and shaped to be separable as chaff from a foodstuff of a crop during harvesting; a sensor to sense a physiochemical parameter relative to growth of the crop; and an energy-harvesting unit to generate electrical energy for the sensor from movement of the housing.

In another example, the present specification describes a method that includes: forming a housing for a crop sensor that encloses a sensor to sense a physiochemical parameter relative to growth of a crop; and including, in the housing, the sensor and an energy-harvesting unit to generate electrical energy for the sensor from movement of the housing.

As used herein and in the following claims, the term “crop” refers to an agricultural crop, which may involve the planting, growing, harvesting or post-harvest processing of a particular foodstuff. Examples of foodstuffs grown as crops include, for example, vegetables of all kinds, tubers and roots of all kinds, including potatoes, grains of all kinds, including corn and rice, legumes of all kinds, fruit of all kinds and others. However, not all foodstuffs are grown as crops.

As used herein and in the following claims, the term “physiochemical parameter” refers broadly to any environmental parameter that effects the health or growth of a crop. For example, physiochemical parameters include, but are not limited to, temperature; moisture; humidity; pressure; pH; pK; pCa; oxygen; carbon dioxide; concentration of important ions such as protons, sodium, potassium, and calcium; and other chemicals (such as ethylene) associated with readiness for harvesting, and the like.

As used herein and in the following claims, the term “additive manufacturing” refers to a variety of manufacturing processes in which a desired object is created by depositing successive layers of material, where each layer of material is selectively solidified into a cross-section of the desired object in accordance with a data model of the desired object.

As used herein and in the following claims, the term “chaff” refers to objects that are naturally collected during the harvesting process for a crop, but which are not the desired foodstuff or are unacceptable instances of the harvested foodstuff. Chaff is separated from the harvested crop so that the harvest contains only usable foodstuff. The separation may be based on, for example, size or weight, or any other sortable characteristic that distinguishes the desired foodstuff from the chaff.

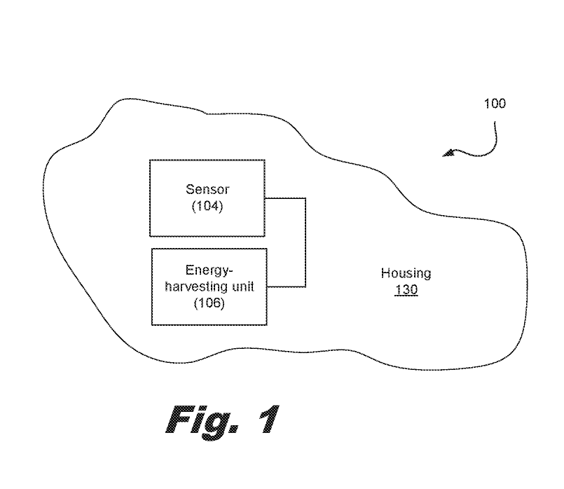

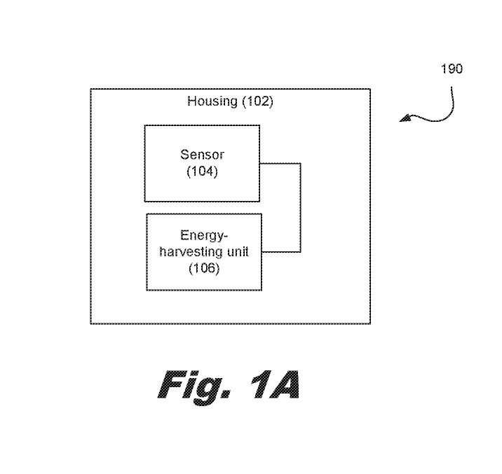

FIG. 1 is an illustration of an example crop sensor consistent with the disclosed implementations. As shown in FIG. 1, the crop sensor (100) includes: a housing (130) sized and shaped to correspond to a foodstuff of a crop; a sensor (104) to sense a physiochemical parameter relative to growth of the crop; and an energy-harvesting unit (106) to generate electrical energy for the sensor (104) from movement of the housing.

The housing (130) can be sized and shaped to mimic any desired foodstuff. The illustrated example might resemble a potato. However, the housing (130) may take the shape of any foodstuff including an ear of corn, a grain of rice or other crops.

The housing (130) may be formed from a variety of methods including, for example, additive manufacturing and molding. An advantage of additive manufacturing is the ability to readily adjust the housing being formed different foodstuffs, different species of a foodstuff or as unique examples of a foodstuff.

The sensor (104) may be a single sensor or may be an array of sensor each sensing a different physiochemical parameter. As noted above, physiochemical parameter that might be sensed by the sensor (104) include, but are not limited to, pH; pK; pCa; temperature; moisture; pressure; concentration of important ions such as protons, sodium, potassium, and calcium; and chemical signals (such as ethylene) associated with readiness for harvesting, and the like.

The crop sensors described herein may accordingly be planted along with a crop, remain in place throughout the growth cycle of the crop and be harvested with the crop. The crop sensors may then be re-deployed in a subsequent crop cycle.

The energy-harvesting unit (106) will produce electrical energy from vibrations or motion in the environment. This energy may be used to power the sensor (104) and/or other components, as will be described herein. For example, the energy-harvesting unit (106) may include a piezo-electric element that, when subject to a compressive force, produces electrical energy. When the unit (100) is harvested with a crop it has been monitoring, for example, there will be movement and vibrations which may be converted into useable electrical energy by the piezo-electric element of the energy-harvesting unit (106). As harvesting will occur at the end of a use cycle of the crop sensor (100), the energy produced by the energy-harvesting unit (106) can ensure operation of the sensor (104) or other components when other energy sources may have become exhausted.

FIG. 1A is an illustration of another example crop sensor (190) consistent with the disclosed implementations. As shown in FIG. 1A, another example of a crop sensor includes: a housing (102) sized and shaped to be separable as chaff from a foodstuff of a crop during harvesting; a sensor (104) to sense a physiochemical parameter relative to growth of the crop; and an energy-harvesting unit (106) to generate electrical energy for the sensor (104) from movement of the housing.

The sensor (104) and energy-harvesting unit (106) in this example may be the same as described above in connection with FIG. 1. However, in this example, the housing (102) is not configured to mimic the foodstuff in the crop being monitored. Rather, the housing (102) is configured to correspond to chaff that is expected to be collected when the foodstuff is harvested. Consequently, whatever process is used to separate the expected chaff from the harvest should also separate the crop sensor (190) from the harvested foodstuff. For this purpose, the housing (102) may be shaped, sized, and/or weighted to match the expected chaff, depending on what parameters are used to separate the chaff from the foodstuff. The sensor units (190) can then be recovered from the chaff using, for example, an applicable technique form the various techniques described below.

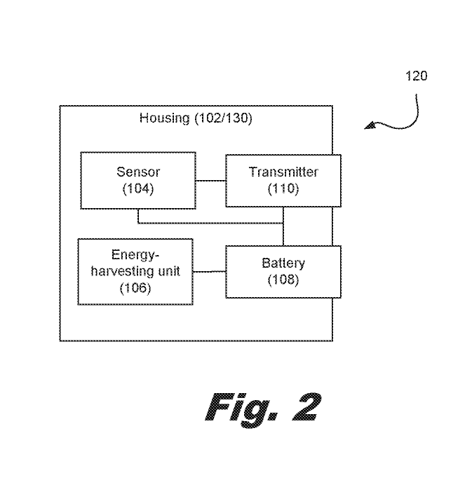

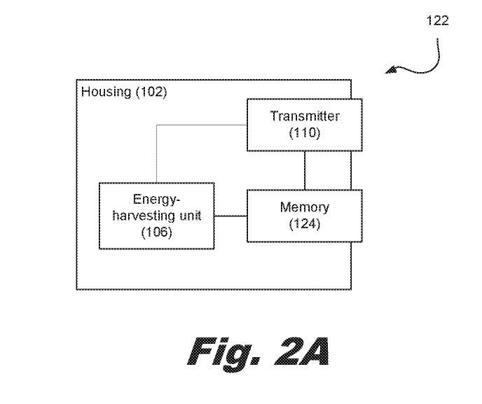

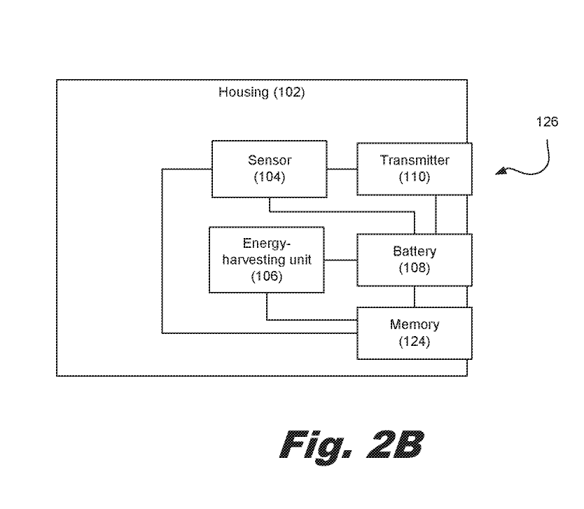

FIG. 2 is an illustration of another example crop sensor consistent with the disclosed implementations. As shown in FIG. 2, this crop sensor unit (120) includes a housing (102/130) which may be configured to match either a foodstuff or the chaff expected to be collected in harvest of a foodstuff. The crop sensor unit (120) also includes a sensor (104) and energy-harvesting unit (106) as described above.

This crop sensor unit (120) may also include a transmitter (110). This transmitter (110) will be a wireless, for example, Radio Frequency (RF) transmitter, and may be active or passive in different examples. An active transmitter makes transmissions using its own power source. A passive transmitter makes transmissions when powered by a signal received from an external reader. Examples of a passive transmitter including a Radio Frequency Identification (RFID) unit.

The transmitter (110) may serve at least two purposes. First, the transmitter (110) may transmit data from the sensor (104). In this way, data from the sensor (104) can be collected at any time during deployment of the unit (120) to inform decisions about crop management. These decisions may include any of the timing of planting or harvesting, the timing and quantity of watering or fertilizing, as well as the composition of fertilizer used. Irrigation, for example, may be automatically controlled based on output from the sensor units described.

Second, the transmitter (110) may output a signal that allows the unit (120) to be located amongst the crop, harvested foodstuff, collected chaff or chaff in the field. This may facilitate recovery of the unit (120) before or after harvest. For example, the crop sensor unit (120) may be collected by drones or robots responding to a signal from the transmitter (110). The term “drones” refers to flight capable robots. Whereas, the term “robots” refers to on-the-ground robotic units that move or are carried by a transport system to collect crop sensor units. If the transmitter is passive, the drones, robots or other collection device may include and operate a reader device corresponding to the passive transmitter.

As shown in FIG. 2, the crop sensor unit (120) may also include a battery (108). This battery (108) may power the sensor (104) and/or the transmitter (110). In such a case, the transmitter (110) may be an active transmitter using power from the battery (108).

Additionally, the energy-harvesting unit (106) may charge or recharge the battery (108). As noted above, the energy-harvesting unit (106) will produce electrical energy from vibrations or motion in the environment. When the unit (120) is harvested with a crop it has been monitoring, there will be movement and vibrations which may be converted into usable electrical energy by the piezo-electric element of the energy-harvesting unit (106). As harvesting will occur at the end of a use cycle of the crop sensor (100), the energy produced by the energy-harvesting unit (106) can ensure operation of the transmitter (110) and/or sensor (104) when the battery (108) may have become exhausted.

FIG. 2A is an illustration of another example crop sensor specifically for training an energy-harvesting unit consistent with the disclosed implementations. The crop sensor unit (122) shown in FIG. 2A may be used in an initial training exercise to prepare for use of the crop sensor units shown, for example, in FIG. 1, FIG. 1A, FIG. 2 and FIG. 2B.

As shown in FIG. 2A, the energy-harvesting unit (106) is connected to either or both of a transmitter (110) and a memory (124). The purpose of the unit (122) is to heuristically measure the vibrations or other mechanical inputs to the energy-harvesting unit (106) during harvesting or other cycles. This data is then stored in the memory (124) and/or transmitted by the transmitter (110) to a receiver. In either case, the characteristic vibrations or other mechanical inputs to the energy-harvesting unit (106) during harvesting or other cycles are measured. This data is then used to tune energy-harvesting units to be particularly responsive to these characteristic mechanical inputs. This tuning may including changing the size, shape, composition, location, natural frequency or other parameters of the energy-harvesting unit (106) to maximize responsiveness to the characteristic vibrations and other mechanical inputs expected in the environment or crop cycle where the unit will be deployed.

FIG. 2B is an illustration of another example crop sensor unit (126) consistent with the disclosed implementations. As shown in FIG. 2B, all the components with their attendant functions described in FIGS. 2 and 2A can be incorporated into a single unit (126). As also shown in FIG. 2B, the sensor (104) may store sensor data in the memory (124). Thus, the sensor data can be transmitted by the transmitter (110), stored in the memory (124) or both.

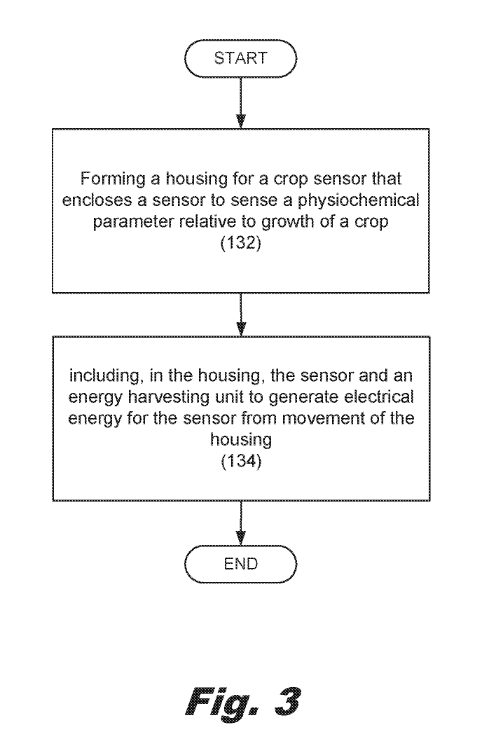

FIG. 3 is a flowchart of an example method of forming a crop sensor consistent with the disclosed implementations. As shown in FIG. 3, the illustrated method includes: forming (132) a housing for a crop sensor that encloses a sensor to sense a physiochemical parameter relative to growth of a crop; and including (134), in the housing, the sensor and an energy-harvesting unit to generate electrical energy for the sensor from movement of the housing.

The housing may be formed using a variety of techniques including molding. With molding, a plastic or other material can be shaped to correspond either to the foodstuff to be monitored or chaff expected to be harvested with that foodstuff, as described above. Once molded, the sensor and energy-harvesting unit, and possibly other combinations of electronics, can be installed inside the molded housing.

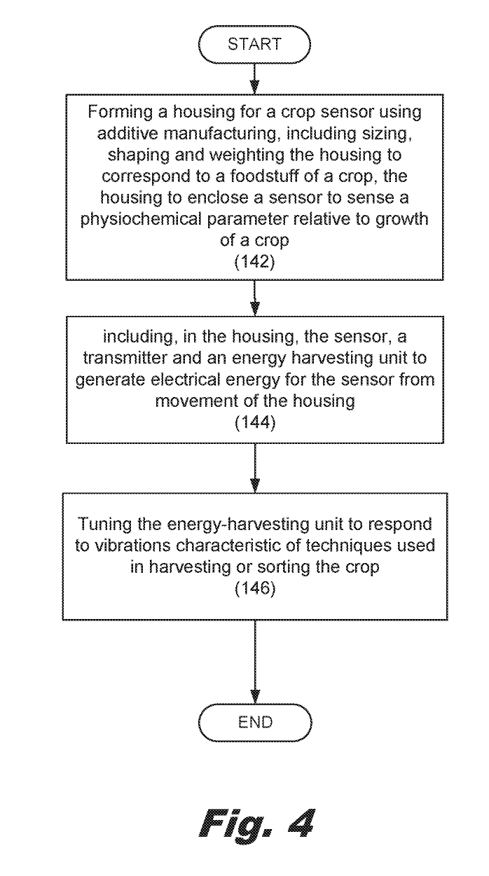

FIG. 4 is a flowchart of another example method of forming a crop sensor consistent with the disclosed implementations. As shown in FIG. 4, the housing for the crop sensor is formed (142) using additive manufacturing. As described above, additive manufacturing refers to a variety of manufacturing processes in which a desired object is created by depositing successive layers of material, where each layer of material is selectively solidified into a cross-section of the desired object in accordance with a data model of the desired object. For example, a layer of liquid or powdered build material may be deposited and then portions of that layer corresponding to a cross-section of the desired object are solidified. Another layer is then deposited and the process repeated. The successive cross-sections of the object are also fused together. In the end, unsolidified build material is removed to leave the only desired object. With additive manufacturing, the housing can be readily adapted to mimic the size, shape, weight, density, surface material properties and morphology, and other physical parameters of either the foodstuff to be monitored or the chaff expected to be collected during harvesting of that foodstuff.

In this way, the housing can be built for, or around, the sensor and energy-harvesting unit, or possibly other combinations of electronics, of the unit. As shown in FIG. 4, this is including (144), in the housing, the sensor, a transmitter and an energy harvesting unit to generate electrical energy for the sensor from movement of the housing.

As also shown in FIG. 4, the method may include tuning (146) the energy-harvesting unit to respond to vibrations characteristic of techniques used in harvesting or sorting the crop. As described above, the characteristic vibrations can be heuristically or empirically determined by monitoring a previous crop cycle. The energy-harvesting unit can then be tuned to respond specifically to those characteristic vibrations or other mechanical inputs so as to maximize the electrical energy output.

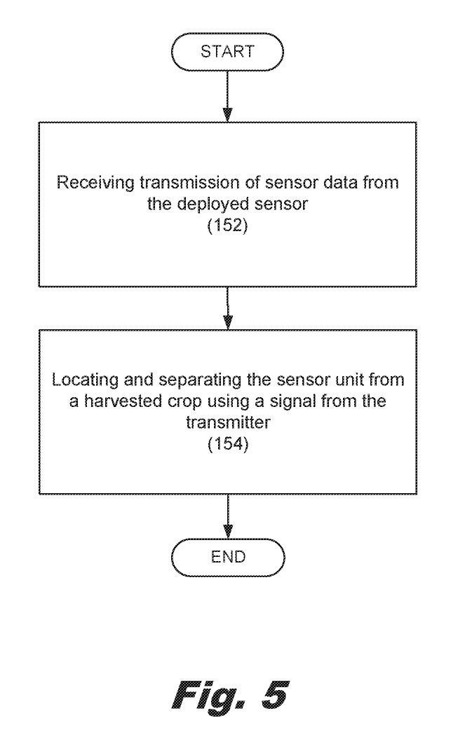

FIG. 5 is a flowchart of an example method of operating a crop sensor consistent with the disclosed implementations. As shown in FIG. 5, a receiver may be receiving (152) transmissions of sensor data from the deployed sensor. These receivers can be deployed around or throughout the area where a crop is being grown. As noted above, the received data, which may be available throughout the crop cycle, can inform decisions about any aspect of managing the crop cycle from planting to harvesting.

When the crop cycle is completed, it will be desired to recover the sensor units for subsequent use. As shown in FIG. 5, this may include locating and separating (154) the sensor unit from a harvested crop using a signal from the sensor unit's transmitter. As described above, drones, robots or other sorting machinery may detect a signal from the sensor unit's transmitter and use that signal to locate the sensor unit and separate it from the harvested crop for subsequent use.

In other examples, where the sensor unit corresponds to chaff, the harvesting process may leave the chaff and the sensor units in the field rather than separating the foodstuff and chaff post-harvest. In these examples, the sensor units may be recovered with or without using a signal from the internal transmitter. For example, robots, drones or other machinery may locate and recover the sensor units based on a signal from the transmitter. Alternatively, robot or hand-held magnetic tools may be used to recover the sensor units with or without a signal from the units transmitter. In such cases, signals from the transmitter may be used simply to confirm that all sensor units have been recovered.

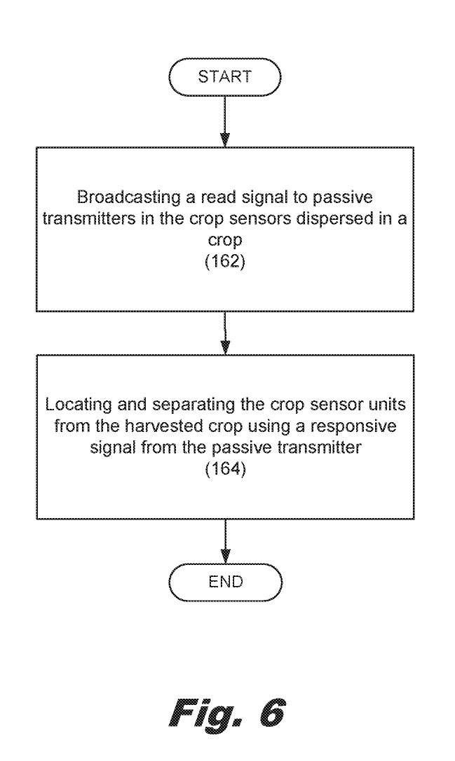

FIG. 6 is a flowchart of another example method of operating a crop sensor consistent with the disclosed implementations. As noted above, the transmitters in the sensor units may be passive transmitters that respond to a broadcast read signal. These transmitters may be, for example, Radio Frequency Identification (RFID) units. Lacking its own power supply, when a passive transmitter receives a broadcast read signal, it uses the energy of that read signal to transmit a reply. This reply may be based on and include data stored in the sensor unit, such as a sensor output indicating the condition of a sensed parameter. In this way, sensor data could be periodically read from a sensor unit by broadcasting (162) a read signal to passive transmitters in the crop sensors dispersed in a crop.

Additionally, after harvesting, the method may include broadcasting a read signal to passive transmitters in the crop sensors in a harvested crop. At this point, the read signal and response from passive transmitters may be used for locating and separating (164) the crop sensor units from the harvested crop, as described above.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A crop sensor comprising:
a housing sized and shaped to correspond to a foodstuff of a crop;
a sensor to sense a physiochemical parameter relative to growth of the crop; and
an energy-harvesting unit to generate electrical energy for the sensor from movement of the housing.

2. The crop sensor of claim 1, further comprising a battery to be charged by the energy-harvesting unit.

3. The crop sensor of claim 1, wherein the energy-harvesting unit comprises a piezoelectric device.

4. The crop sensor of claim 1, wherein the energy-harvesting unit is tuned to generate electrical energy from vibrations corresponding to a harvesting process for the crop.

5. The crop sensor of claim 1, wherein the housing comprises layers of material formed by additive manufacturing.

6. The crop sensor of claim 1, wherein the housing corresponds to the weight of the foodstuff.

7. The crop sensor of claim 1, further comprising a transmitter to transmit data.

8. The crop sensor of claim 7, wherein the transmitter is passive device.

9. A method comprising:
forming a housing for a crop sensor that encloses a sensor to sense a physiochemical parameter relative to growth of a crop; and
including, in the housing, the sensor and an energy-harvesting unit to generate electrical energy for the sensor from movement of the housing.

10. The method of claim 9, further comprising using additive manufacturing to form the housing including sizing and shaping the housing to correspond to a foodstuff of the crop.

11. The method of claim 9, further comprising tuning the energy-harvesting unit to respond to vibrations characteristic of techniques used in harvesting or sorting the crop.

12. The method of claim 9, further comprising including a transmitter in the housing.

13. The method of claim 12, further comprising locating and separating the housing from a harvested crop using a signal from the transmitter.

14. A crop sensor comprising:
a housing sized and shaped to be separable as chaff from a foodstuff of a crop during harvesting;
a sensor to sense a physiochemical parameter relative to growth of the crop; and
an energy-harvesting unit to generate electrical energy for the sensor from movement of the housing.

15. The crop sensor of claim 14, further comprising a battery to be charged by the energy-harvesting unit.
